(19) United States
(12) Patent Application Publication
(10) Pub. No.: US 2026/0350235 A1
(43) Pub. Date: Nov. 5, 2026

(54) HASHING CIRCUITRY FOR HARDWARE ROOT OF TRUST

(71) Applicant: Siemens Industry Software Inc., Plano, TX (US)

(72) Inventors: Janusz Rajski, West Linn, OR (US); Trawka Maciej, Pruszcz Gdanski (PL); Jerzy Tyszer, Poznan (PL)

(73) Assignee: Siemens Industry Software Inc., Plano, TX (US)

(21) Appl. No.: 19/100,008

(22) PCT Filed: Aug. 8, 2022
(86) PCT No.: PCT/US2022/039712

§ 371 Date: Jan. 30, 2025

(51) Int. Cl. G06F 21/72; G06F 7/58; H04L 9/32

(52) U.S. Cl. CPC G06F 21/72; G06F 7/588; H04L 9/3242

(57) ABSTRACT

Hashing circuitry is configured to mimic a hashing function that can transform a random number into a hash value. The hashing circuitry comprises combinational circuitry with its inputs receiving bits of the random number and a ring generator configured to be initialized by a secret key, to be injected with bits from outputs of the combinational circuitry, and to output the hash value after a predefined number of clock cycles. The combinational circuitry comprises logic gates configured to serve as nonlinear Boolean operators. The random number may be generated by a random number generator comprising a ring generator and one or more inverter-based ring oscillators. The hash value may be employed by retrieving circuitry to retrieve one or more configuration masks from a response signal generated by a computing device based on the random number.

### FIELD OF THE DISCLOSED TECHNIQUES

The presently disclosed techniques relate to the field of hardware security and trust. Various implementations of the disclosed techniques may be particularly useful for designing and using hashing circuitry and associated hardware roots of trust to protect circuits against malicious activities and hacking attempts.

### BACKGROUND OF THE DISCLOSED TECHNIQUES

The huge cost of building and maintaining integrated circuit manufacturing has pushed many semiconductor companies to become fabless, outsourcing the expensive fabrication process to foundries. The lack of reliable monitoring and trustworthiness to offshore fabrication and testing processes increases security threats. Hardware security threats can be in many forms including intellectual property (IP) piracy, overproduction, counterfeiting, reverse engineering, and insertion of hardware Trojans.

To mitigate the security risks, various defense solutions have been proposed such as logic locking, circuit obfuscation, password-based authentication, challenge-response protocols, and data encryption. The foundation on which many secure operations of an integrated circuit depend is typically defined as a hardware root of trust (RoT). Hardware roots of trust can perform specific, critical security functions. For example, high-end roots of trust are usually integrated into silicon as separate, custom-designed security modules—immune from malware attacks—that handle chip and device identities, cryptographic keys and functions, secure boot processes, attestation, authentication, firmware updates, etc. As a security vehicle, the hardware root of trust should be capable of detecting the intrusion, disabling access pending further actions, and/or obfuscating (camouflaging) logic operations of the IC. Choosing an adequate root of trust depends on many factors, such as a threat model, potential risks, a desired level of protection, programmability, silicon overhead, impact on performance, or the complexity of crypto algorithms and ciphers.

Existing hardware roots of trust are facing many challenges. One challenge is about tradeoffs between meeting security demands and preserving functionality and testability. Another challenge is the complexity of several existing solutions and their impact on area overhead and the design flow. These challenges can make integrated circuit vendors hesitate to adopt the existing solution. An effective and non-intrusive lightweight hardware root of trust is thus highly desirable.

A hardware root of trust solution typically employs a hash function that can convert a random number produced by a circuit into a hash value. The random number sometimes is also referred to as nonce. A nonce may contain additional information such as the circuit's electronic identification number. The hashing process can be performed concurrently by on-chip hash circuitry and by an off-chip security processor. The security processor can use the hash value to generate a response to the received nonce. The on-chip generated hash value and the response received by the circuit can then be used to perform various security functions such as authentication and obfuscating (camouflaging) logic operations. Considering the practical hardware implementation complexity, on-chip hashing circuitry is preferable to be easily designed, synthesized, and implemented with modern digital design blocks.

### BRIEF SUMMARY OF THE DISCLOSED TECHNIQUES

Various aspects of the disclosed technology relate to hashing circuitry and hardware root of trust circuits that employ it. In one aspect, there is a circuit, comprising: hashing circuitry configured to mimic a hashing function that can transform a random number into a hash value, the hashing circuitry comprising: combinational circuitry comprising logic gates configured to serve as nonlinear Boolean operators, inputs of the combinational circuitry receiving bits of the random number; and a ring generator configured to be initialized by a secret key, to be injected with bits from outputs of the combinational circuitry, and to output the hash value after a predefined number of clock cycles.

The circuit may further comprise: a nonvolatile storage device configured to store the secret key.

The combinational circuitry may be configured to receive a preset number of bits of the random number per clock cycle and to inject bits into the ring generator continuously for a plurality of clock cycles.

The circuit may further comprise a random number generator configured to generate the random number. The random number generator may comprise a ring generator and one or more inverter-based ring oscillators, the one or more inverter-based ring oscillators configured to inject bits into the ring generator at a plurality of location. At least one of the one or more inverter-based ring oscillators may be configured to inject bits from outputs of some or all inverting elements (inverting devices) in the at least one of the one or more inverter-based ring oscillators. The random number generator may further comprise blocking circuitry configured to convert, based on a blocking signal, the ring generator into a circular shift register by blocking both the injection from the one or more inverter-based ring oscillators and internal feedbacks in the ring generator.

The circuit may still further comprise retrieving circuitry configured to use the hash value to retrieve one or more configuration masks from a response signal received by the circuit, wherein the response signal is generated based on the random number by a computing device, the generating of the response signal comprising: generating the hash value for the random number, and combining the hash value with the one or more configuration masks.

The circuit may still further comprise a descrambler configured to use a configuration mask in the one or more configuration masks to descramble a signal received by the circuit, a scrambler configured to use a configuration mask in the one or more configuration masks to scramble a signal to be sent out by the circuit, or both.

The descrambling the signal may comprise retrieving compressed test patterns from encrypted compressed test patterns received by the circuit.

The circuit may still further comprise a controller configured to supervise an authentication process, the authentication process comprising: generating the random number by the random number generator, converting the random number into the hash value by the hashing circuitry, and retrieving, by the retrieving circuitry, the one or more configuration masks from the response signal received by the circuit based on the hash value. The controller may comprise a finite state machine.

In another aspect, there are one or more non-transitory computer-readable media storing computer-executable instructions for causing one or more processors to perform a method, the method comprising: creating the above circuit in a circuit design.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclosed techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates an example of hashing circuitry that may be implemented according to various embodiments of the disclosed technology.

FIG. 2A illustrates an example of a 28-bit ring generator implementing a primitive characteristic polynomial.

FIG. 2B illustrates an example of a 28-bit dense ring generator implementing a primitive characteristic polynomial.

FIG. 3 illustrates an example process for validating the hash circuitry that may be implemented according to various embodiments of the disclosed technology.

FIG. 4 illustrates an example histogram summarizing the results of the hash circuitry validation process shown in FIG. 3.

FIG. 5 illustrates a table summarizing results obtained for different nonce sizes, different sizes of ring generators and two durations of the hash circuitry validation process shown in FIG. 3.

FIG. 6A illustrates an example true random number generator that can be used to implement an on-chip random number generator according to various embodiments of the disclosed technology.

FIG. 6B illustrates another example true random number generator that can be used to implement an on-chip random number generator according to various embodiments of the disclosed technology.

FIG. 6C illustrates an example 32-bit true random number generator based on a 32-bit ring generator that may be implemented according to various embodiments of the disclosed technology.

FIG. 7 illustrates an example of hashing circuitry combined with a true random number generator that may be implemented according to various embodiments of the disclosed technology.

FIG. 8 illustrates an example of a hardware-root-of-trust system that may be implemented according to various embodiments of the disclosed technology.

FIG. 9 illustrates an example descrambler that may be implemented according to various embodiments of the disclosed technology.

FIG. 10 illustrates an example of a controller that may be implemented according to various embodiments of the disclosed technology.

FIG. 11 illustrates an example of a programmable computer system with which various embodiments of the disclosed technology may be employed.

### DETAILED DESCRIPTION OF THE DISCLOSED TECHNIQUES

Various aspects of the disclosed technology relate to hashing circuitry and hardware root of trust circuits that employ it. In the following description, numerous details are set forth for the purpose of explanation. However, one of ordinary skill in the art will realize that the disclosed technology may be practiced without the use of these specific details. In other instances, well-known features have not been described in details to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “configure,” “transform,” and “inject” to describe the disclosed method or the device function/structure. Such terms are high-level descriptions. The actual operations or functions/structures that correspond to these terms will vary depending on the particular implementation and are readily discernible by one of ordinary skill in the art.

As used in this disclosure, the singular forms “a,” “an,” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements not affecting the intended operation of the circuit.

Additionally, as used herein, the term “design” is intended to encompass data describing an entire integrated circuit device. This term also is intended to encompass a smaller group of data describing one or more components of an entire device such as a portion of an integrated circuit device nevertheless.

As noted previously, hashing is often employed by hardware root of trust. On the secured server side, a processor can use a hash function to compute a hash value from a nonce produced by a circuit. The hash value can serve as or be used to generate a response to the nonce. On the circuit side, hashing circuitry can mimic the hashing function to transform the nonce into the same hash value as the one computed by the processor. The circuit can then use the response and the on-chip-generated hash value to perform security-related tasks.

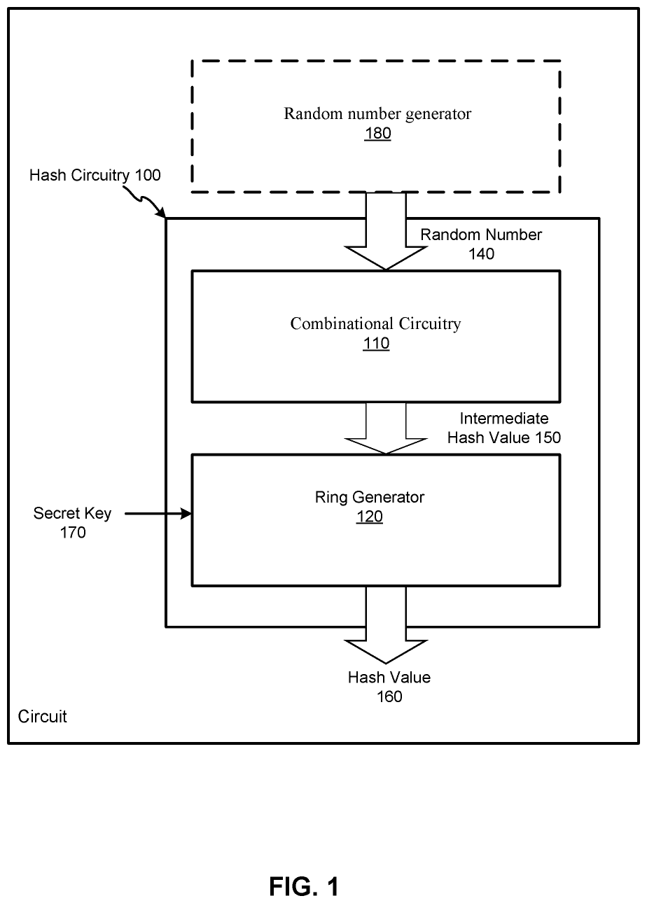

FIG. 1 illustrates an example of hashing circuitry 100 that may be implemented according to various embodiments of the disclosed technology. The hashing circuitry 100 comprises combinational circuitry 110 and a ring generator 120. The combinational circuitry 110 comprises logic gates and can be taken from a class of hash functions. Each member of the class comprises a number of nonlinear Boolean operators as well as simple logic functions in their canonical forms. Selection of a particular hash function can be decided on the basis of the size of random number 140 and the ring generator 120. The combinational circuitry 110 can transform the random number 140 into an intermediate hash value 150. The ring generator 120 is configured to mutate the intermediate hash value 150 and transform it into a hash value 160. To perform the transformation, the ring generator 120 is first initialized by a secret key 170 and is then injected with some bits of the intermediate hash value 150 from outputs of the combinational circuitry 110. The secret key 170 may be stored in an encoded form in a nonvolatile on-chip tamper-proof memory. The secret key 170 can be serially uploaded into the ring generator 120 prior to the actual hashing clock cycles. During the actual hashing clock cycles, several bits of the intermediate hash value 150 are continuously available at the outputs of the combinational circuitry 110. After a predefined number of clock cycles that suffice to rotate the content of the ring generator 120 multiple times, the hash value 160 is finalized and ready to be used for subsequent applications.

Ring generators are a type of linear finite state machines, which can be derived by altering the canonical forms (external feedback, internal feedback) of linear feedback shift registers while maintaining their transition functions. An example of the altering is the m-sequence preserving transformations described in G. Mrugalski, J. Rajski, J. Tyszer, “Ring Generators—New Devices for Embedded Test Applications,” IEEE Trans. Computer-Aided Design, vol. 23, no. 9, pp. 1306-1320, 2004. Like linear feedback shift registers, ring generators can be used in various circuit test applications such as pseudorandom test pattern generation, on-chip test data decompression, and test response compaction. It has been shown that after applying the transformations to linear feedback shift registers in a certain order, the resultant ring generators feature a significantly reduced number of levels of XOR logic, minimized internal fan-outs, and simplified circuit layout and routing, as compared to conventional linear feedback shift registers and cellular automata. Consequently, ring generators have highly modular structures and can operate at high speeds.

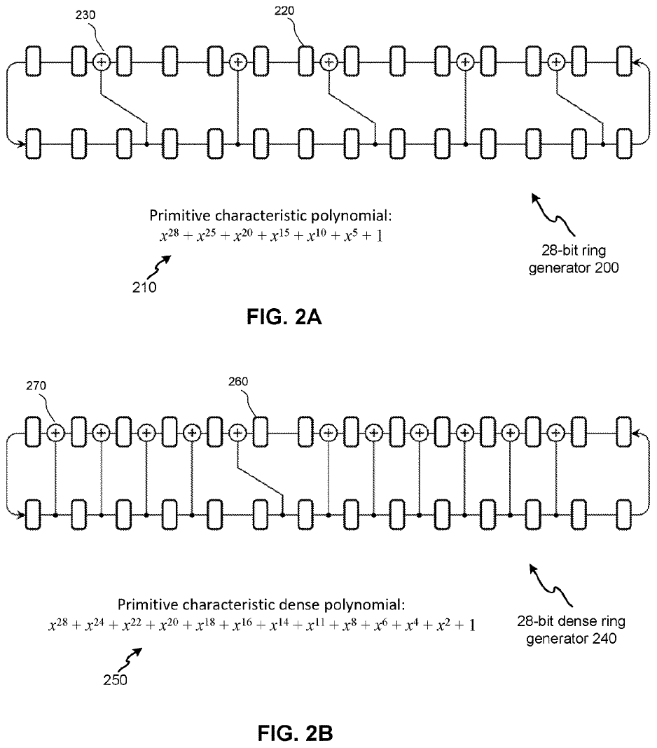

FIG. 2A illustrates an example of a 28-bit ring generator 200 implementing a primitive characteristic polynomial 210. The 28-bit ring generator 200 comprises twenty-eight state elements 220 and five XOR gates 230. Each of the XOR gates 230 is located at a feedback location in a ring formed by the state elements 220 and one of its input is connected to a feedback tap via a feedback line. The state elements 220 can be implemented using flip-flops. As the figure shows, the feedback logic for the 28-bit ring generator 200 has only one two-input XOR gate per feedback line, so the number of levels of logic is 1, smaller than 2 and log₂k for a cellular automaton and the external feedback form of linear feedback shift registers (k is the number of XOR gates), respectively. Also as indicated by the figure, the 28-bit ring generator 200 does not use long feedback lines which are needed in the internal feedback form of linear feedback shift registers. Therefore, ring generators are faster than both the two canonical forms of linear feedback shift registers and cellular automata.

FIG. 2B illustrates an example of a 28-bit dense ring generator 240 implementing a primitive characteristic polynomial 250. The 28-bit dense ring generator 240 comprises twenty-eight state elements 260 and eleven XOR gates 270. The large number of XOR gates 270 leads to the dense characteristic polynomial 250 which has thirteen non-zero terms, compared to seven non-zero terms of the primitive characteristic polynomial 210. Dense ring generators, when used for test data decompression, are capable of driving a large number of scan chains by using either outputs taken directly from the feedback logic or phase shifters that are tapped locally from consecutive locations. This can allow designers to minimize routing complexity, optimize wire sizing, and make the overall layout compact. It should be noted that either conventional ring generators like the 28-bit ring generator 200 or dense ring generators like the 28-bit dense ring generator 240 can be used to implement the ring generator 110 in the hashing circuitry 100 in FIG. 1.

A desirable feature of a hash function is the “avalanche effect”: a small change in the input of the hash function can result in a significant change in the output of the hash function. The avalanche effect can make the hash value statistically indistinguishable from a random number. The hashing circuitry 100 may be validated by using the following process to show whether the hashing circuitry 100 can cause the avalanche effect: flipping a single bit of a random number; and then checking how many bits of the hash value are changed as a result which is equivalent to determining the Hamming distance of the new hash value from the original hash value. The process may be repeated for a large number of times to compute the average Hamming distance.

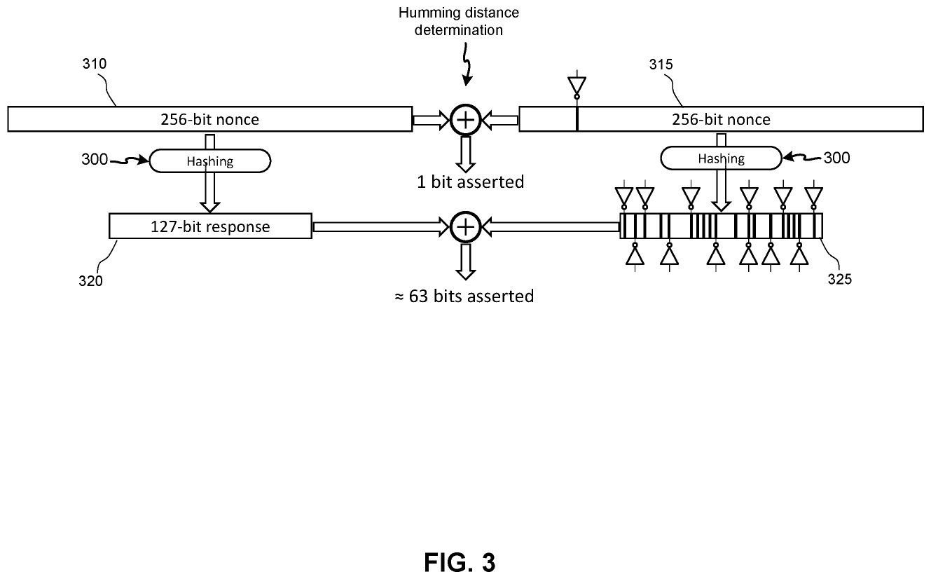

FIG. 3 illustrates an example process for validating the hash circuitry that may be implemented according to various embodiments of the disclosed technology. Hashing circuitry 300 comprises a 127-bit ring generator and can transform a 256-bit random number 310 into a 127-bit hash value 320. A new 256-bit random number 315 can be obtained by flipping one bit of the 256-bit random number 310. The Hamming distance of the new 256-bit random number 315 from the 256-bit random number 310 is obviously one. The Hashing circuitry 300 can transform the new 256-bit random number 315 into a new 127-bit hash value 325. The average Hamming distance of the new 127-bit hash value 325 from the 127-bit hash value 320 is determined to be about 63 after performing the above flipping process a number of times. This shows a good avalanche effect, i.e., a single-bit complement of the random value causes approximately half the response bits to flip relative to a hash value obtained for the base random value. In other words, whenever a single bit of a random number is complemented, each bit of the hash value changes with the probability of 0.5.

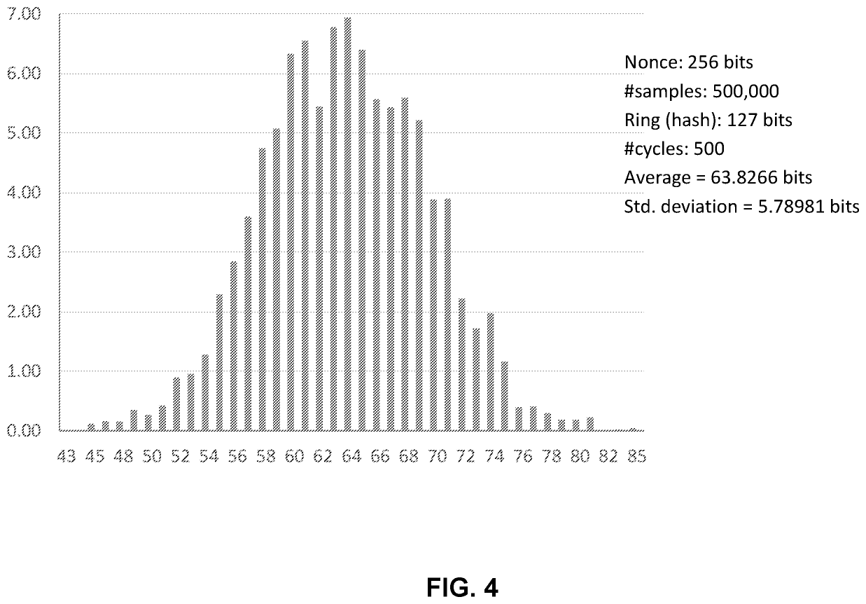

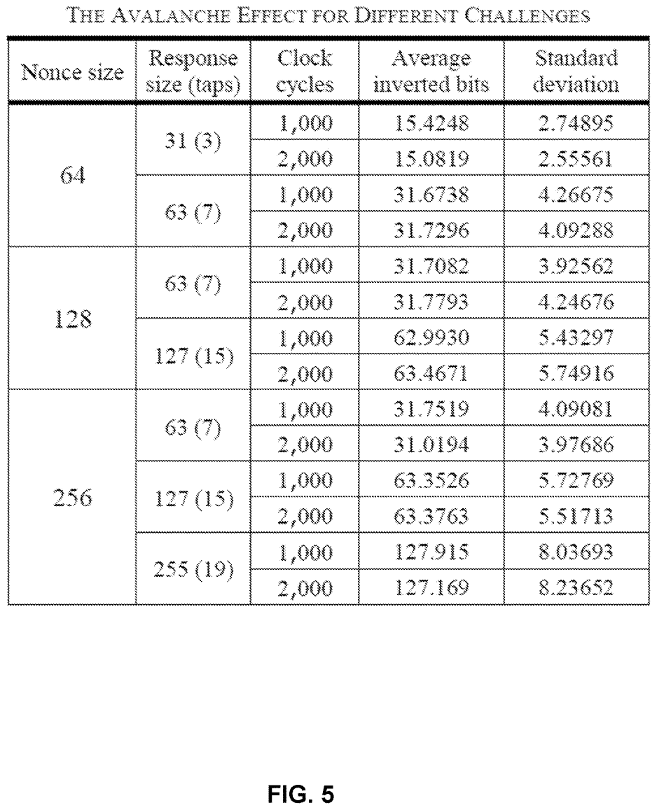

FIG. 4 illustrates an example histogram summarizing the results of the hash circuitry validation process shown in FIG. 3. The histogram is obtained for 500,000 256-bit random numbers. For each of the 500,000 256-bit random numbers, one bit is flipped at a time to produce 64 different derivatives (inverting every fourth bit of the base random number). Both the base random numbers and their derivatives are hashed by using hashing circuitry like the hashing circuitry 110 in FIG. 1 which employs a 127-bit ring generator running for 1,500 clock cycles. To get the kth entry of the histogram, the number of hashes whose Hamming distance from a hash obtained for the base random number is k is counted. The result shows that 63.8266 bits, i.e., approximately 50%, have changed, on average, in a response to a single bit inversion, with the corresponding standard deviation equal to 5.78981. Similar results are obtained for different nonce sizes, different sizes of ring generators and two durations of the hashing process, which are summarized in a table in FIG. 5. The table also indicates the number of feedback taps which each of the characteristic polynomials is deploying. As can be seen, these instances exhibit a good avalanche effect, i.e., a single-bit complement of the nonce value causes approximately half the response bits to flip relative to a hash value obtained for the base nonce.

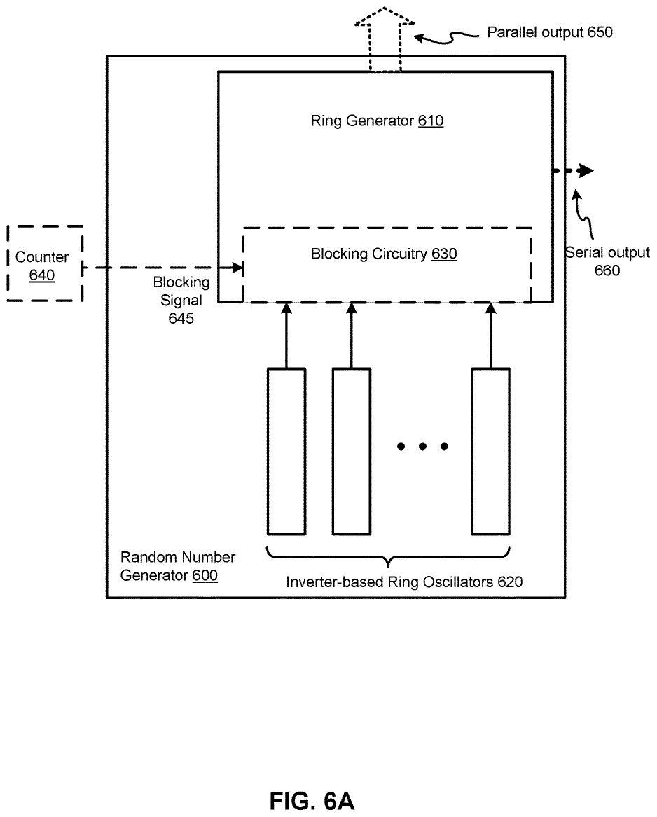

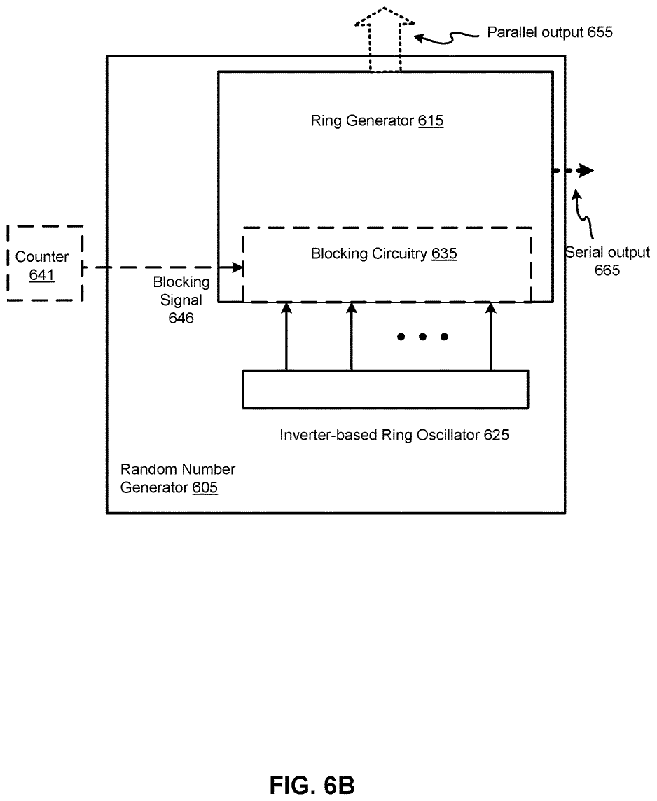

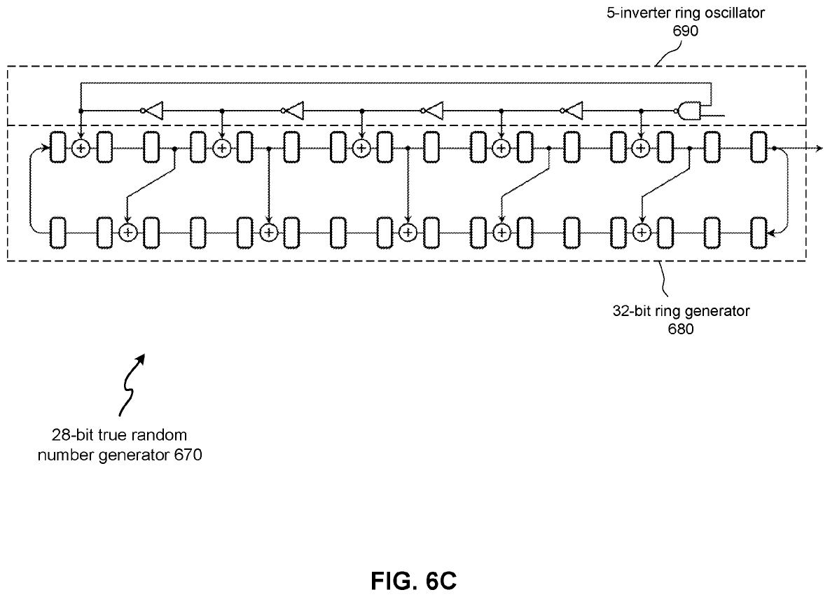

Referring back to FIG. 1, the random number 140 may be generated by an on-chip random number generator 180. From the security perspective, the random numbers generated by pseudo-random number generators are secure against some brute-force attacks due to the large pattern space. True random number generators, however, can be more effective against security risks since pseudo-random number generators have deterministic output patterns which are still vulnerable to cryptanalytic attacks. FIG. 6A illustrates an example true random number generator 600 that can be used to implement the on-chip random number generator 180 according to various embodiments of the disclosed technology. The true random number generator 600 comprises a ring generator 610 and a plurality of inverter-based ring oscillators 620. Each of the plurality of inverter-based ring oscillators 620 is configured to inject bits into the ring generator 610 at a unique location. With various implementations of the disclosed technology, each of the plurality of inverter-based ring oscillators 620 may comprise a unique number of inverting elements (inverting devices). Examples of the inverting elements are NOT gates and NAND gates.

The ring generator 610 can be implemented by using either conventional ring generators like the 28-bit ring generator 200 in FIG. 2A or dense ring generators like the 28-bit dense ring generator 240 in FIG. 2B. As discussed previously, the ring generator 610 can produce a sequence of pseudorandom numbers by itself. The injections from the plurality of inverter-based ring oscillators 620 transform the ring generator 610 into a true random number generator. Each of the plurality of inverter-based ring oscillators 620 injects the logic value of 1 into the ring generator 610 with a frequency that depends on the integrated circuit fabrication process and the number of inverting elements used. The stochastic characteristics present in the integrated circuit fabrication process thus supplies desired uncertainty (entropy) or randomness. Further, since the clocking of the ring generator 610 is inherently asynchronous to the state of every ring oscillator 620, many clock samples may also stress the metastable region of the flip-flops of the ring generator 610 (due to setup and hold time violations), thereby producing an additional randomness.

The true random number generator 600 may further comprise blocking circuitry 630 configured to convert, based on a blocking signal 645, the ring generator 610 into a circular shift register by blocking both the injection from the plurality of inverter-based ring oscillators 620 and internal feedbacks in the ring generator 610. The blocking signal 645 can be configured to change from unblocking to blocking when the content of the ring generator 610 is ready to be sent out. Typically, the change occurs after a predefined number of clock cycles dictated by a counter 640. The counter 640 can be inside or outside a controller. The content of the ring generator 610 can be sent out via a serial output 660, a parallel output 650, or both.

FIG. 6B illustrates another example true random number generator 605 that can be used to implement the on-chip random number generator 180 in FIG. 1 according to various embodiments of the disclosed technology. The true random number generator 605 comprises a ring generator 615 and an inverter-based ring oscillator 625. Both the ring generator 615 and the inverter-based ring oscillator 625 can be constructed using digital components. The inverter-based ring oscillator 625 is configured to inject bits into the ring generator 615 at multiple locations from outputs of multiple selected inverting elements in the inverter-based ring oscillator 625.

The ring generator 615 can be implemented by using either conventional ring generators like the 28-bit ring generator 200 in FIG. 2A or dense ring generators like the 28-bit dense ring generator 240 in FIG. 2B. The inverter-based ring oscillator 625 operates with a frequency that depends on the circuit fabrication process, the number of logic elements it deploys, and the delay of its routing path. Sampling many inverters can populate a relatively long interval with the timing jitter, hence maximizing the probability that at least one noisy signal edge is captured in the ring generator 615. Consequently, the ring generator 615 acts as a special form of a bit extractor processing data collected at several stages of the inverter-based ring oscillator 625. Furthermore, since the clocking of the ring generator 615 is inherently asynchronous to the state of the inverter-based ring oscillator 625, some clock samples may stress the metastability region of the ring generator flip-flops (due to setup and hold time violations), thereby producing an additional uncertainty (entropy) or randomness.

Similar to the true random number generator 600, the true random number generator 605 may further comprise blocking circuitry 635 configured to convert, based on a blocking signal 646, the ring generator 615 into a circular shift register by blocking both the injection from the inverter-based ring oscillator 625 and internal feedbacks in the ring generator 615. The counter 641 can supply the blocking signal 646. The counter 641 can be inside or outside a controller. The content of the ring generator 615 can be sent out via a serial output 665, a parallel output 655, or both.

FIG. 6C illustrates an example 32-bit true random number generator 670 based on a 32-bit ring generator 680 that may be implemented according to various embodiments of the disclosed technology. In addition to the 32-bit ring generator 680, the 32-bit true random number generator 670 comprises a 5-inverter ring oscillator 690. The outputs of five inverting elements (four inverters and one NAND gate) of the 5-inverter ring oscillator 690 can inject bits into the 32-bit ring generator 680 through XOR gates at five different locations, respectively. It should be noted that in some embodiments of the disclosed technology, not all outputs of the inverting elements are used for injecting bits into the ring generator.

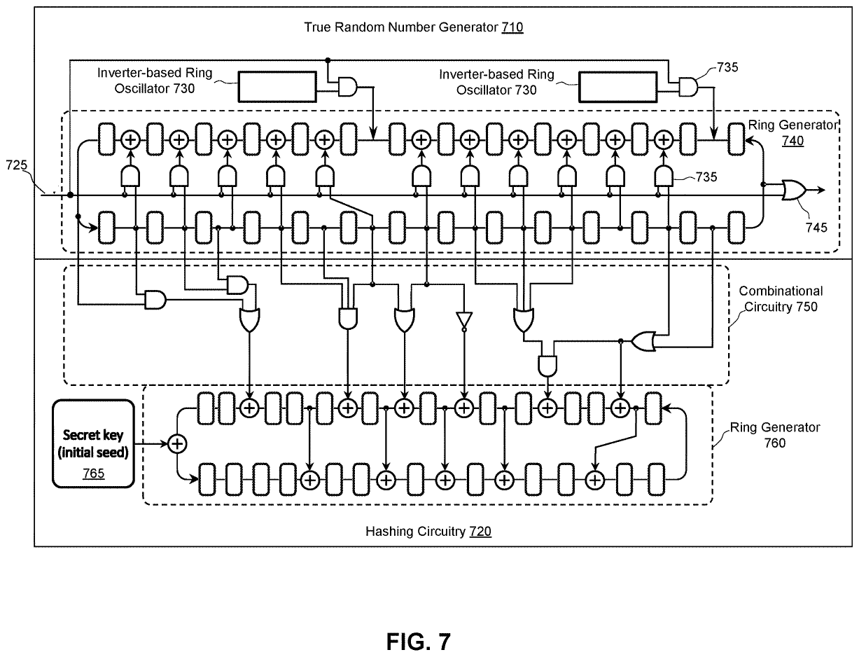

FIG. 7 illustrates an example of hashing circuitry 720 combined with a true random number generator 710 that may be implemented according to various embodiments of the disclosed technology. The true random number generator 710 comprises a ring generator 740, two inverter-based ring oscillators 730, blocking circuitry formed with thirteen AND gates 735, and an OR gate 745 configured to control a serial output of the true random number generator 710. The ring generator 740 is a 28-bit dense ring generator, similar to the 28-bit dense ring generator 240 in FIG. 2B. The two inverter-based ring oscillators 730 may be implemented by using two ring oscillators having different numbers of inverting elements such as a 3-inverter ring oscillator and a 5-inverter ring oscillator.

When a blocking signal 725 is changed to the logic value of zero, the AND gates 735 transform the ring generator 740 into a circular shift register by blocking both the injection from the inverter-based ring oscillators 730 and internal feedbacks in the ring generator 740. Typically, the change occurs after a predefined number of clock cycles which can be controlled by a counter (not shown in the figure). The blocking signal 735 can also control the serial output of the true random number generator 710 via the OR gate 745. The serial output can be used to form a nonce which is then sent to a security server outside the chip.

The hashing circuitry 720 comprises combinational circuitry 750 and a ring generator 760. The combinational circuitry 750 comprises AND gates, OR gates, and an inverter, and has 13 inputs and 6 outputs. The combinational circuitry 750 is configured to use bits outputted from the ring generator 740 to produce an intermediate hash value after the blocking signal 735 transforms the ring generator 740 into a circular shift register. The transformation spans over several stages of this circular shift register. The final hash value is formed by the ring generator 760. As discussed previously, a secret key 765 is used to initialize the ring generator 760 prior to the actual hashing clock cycles, and the ring generator 760 can then mutate the intermediate hash value based on a primitive feedback polynomial it employs. The hashing process performed in the ring generator 760 comprises injecting several bits that are continuously available at the six outputs of the combinational circuitry 750 and rotating the content of the ring generator 760 multiple times. This can be controlled by a counter which is not shown in FIG. 7. This counter can be the same counter used to control the change of the blocking signal 725. It should be noted that there may be other control circuitry in addition to the counter, of which some components may be placed between and/or within each of the true random number generator 710 and the hashing circuitry 720.

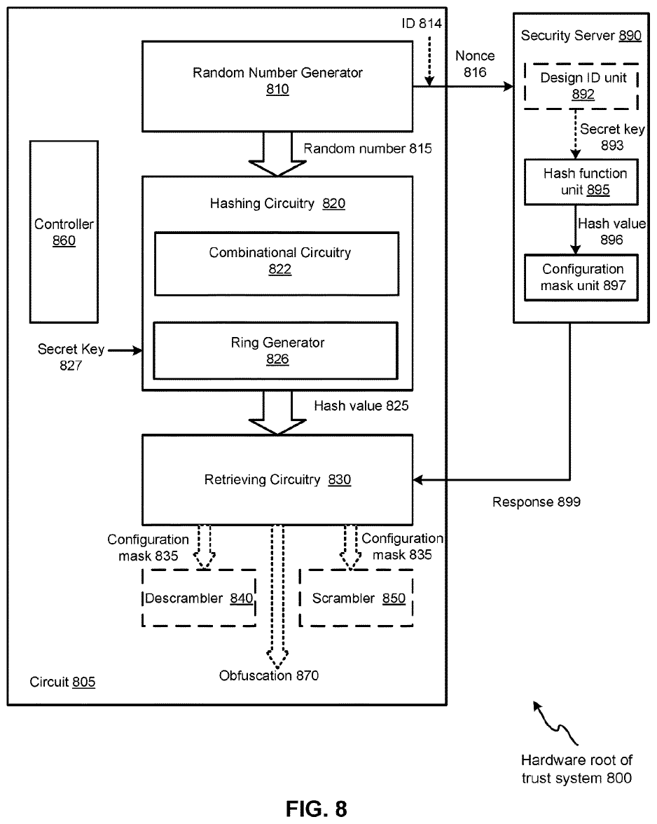

FIG. 8 illustrates an example of a hardware-root-of-trust system 800 that may be implemented according to various embodiments of the disclosed technology. The hardware-root-of-trust system 800 comprises components in both a circuit 805 and a security server 890. The components in the circuit 805 comprises a random number generator 810, hashing circuitry 820, retrieving circuitry 830, and a controller 860. The components in the security server 890 comprises a hash function unit 895 and a configuration mask unit 897.

The random number generator 810 can be prompted to generate a random number 815. A request received by the circuit 805 to run a certain function, for example, can be set to cause such an action. The circuit 805 then sends to the security server 890 a nonce 816 formed based on the random number 815. The nonce 816 may contain only the random number 815 or may further contain some individual data from the circuit 805 such as its electronic design identification number 814. The random number generator 810 can be implemented using the true random number generator 600 in FIG. 6A or the true random number generator 605 in FIG. 6B according to various embodiments of the disclosed technology.

The hashing circuitry 820 comprises combinational circuitry 822 and a ring generator 826. Like the hashing circuitry 100 in FIG. 1, the combinational circuitry 822 can transform the random number 815 into an intermediate hash value. The ring generator 826 can then transform the intermediate hash value into a hash value 825. The overall hash function which the hashing circuitry 820 is configured to mimic the same hash function employed by the hash function unit 895 in the security server 890.

The hash function unit 895 use the hash function to compute a hash value 896 for the received nonce 816. In normal operations, the hash value 896 should be the same as the hash value 825. The computation may involve a secret key 893 that is used as an initial value for hashing the random number 815 included in the nonce 816. The security server 890 may further comprise a design identification (Design ID) unit 892. The design identification unit 892 can verify the electronic design identification number 814 and based on it, retrieve the secret key 893 to be used by the hash function unit 895. If the electronic design identification number 814 is invalid, the security server 890 may still generate a unique and fake initial hash value and use it to obfuscate the resultant response. The security server 890 may also keep track of how many times each individual chip requested a response, monitoring any unusual behavior. The same (valid) secret key 827 can be kept in an encrypted form by the circuit 805 and used by the hashing circuitry 820 in a way similar to how the hash function unit 895 uses the secret key 893.

The configuration mask unit 897 in the security server 890 can combine the hash value 896 with one or more configuration masks to generate a response 899. One example of the configuration masks is a configuration mask that can be employed for descrambling encrypted data into original data. Another example is a configuration mask that can be employed for scrambling original data into encrypted data. With various implementations of the disclosed technology, the configuration mask unit 897 can perform a bit-wise XOR operation combining bits of the one or more configuration masks with bits of the hash value 896. In addition to the one or more configuration masks, other items may also be XORed with the hash value 896. Alternatively or additionally, some bits of the hash value 896 may be left unchanged.

After the circuit 805 receives the response 899 from the security server 890, the retrieving circuitry 830 can use the hash value 825 received from the hashing circuitry 820 to retrieve the one or more configuration masks 835 from the response 899. If the one or more configuration masks 835 are XORed with the hash value 896 in a bitwise operation by the configuration mask unit 897 as described above, the retrieving circuitry 830 can use XOR gates to perform a bitwise retrieving operation.

The circuit 805 may further comprise a descrambler 840, a scrambler 850, or both. The descrambler 840 can use one of the one or more configuration masks 835 to retrieve original data from encrypted data received by the circuit 805. For example, the descrambler 840 can be configured to retrieve compressed test patterns from encrypted compressed test patterns received by the circuit 805. The scrambler 850 can use another one of the one or more configuration masks 835 to encrypt data that need to be sent out by the circuit 805. For example, the scrambler 850 can be configured to encrypt test responses or compacted test response before they are sent out by the circuit 805 for analysis.

An attempt to unauthorized access may trigger twofold changes in the circuit internal functionality if both the descrambler 840 and the scrambler 850 are in the circuit 805. First, the descrambler 840 and the scrambler 850 become blurred due to corrupted configuration masks. Second, the remaining bits (obfuscation 870) of the response 899 if any can be used to hide design functionality from adversaries in the process of logic obfuscation. The logic obfuscation can result in signal corruptions caused by activation of certain elements. Alternatively, any mismatch between some bits of the hash value 825 and the hash value 896 may launch a simple logic locking scheme, disabling access to the genuine functionality of the circuit 805.

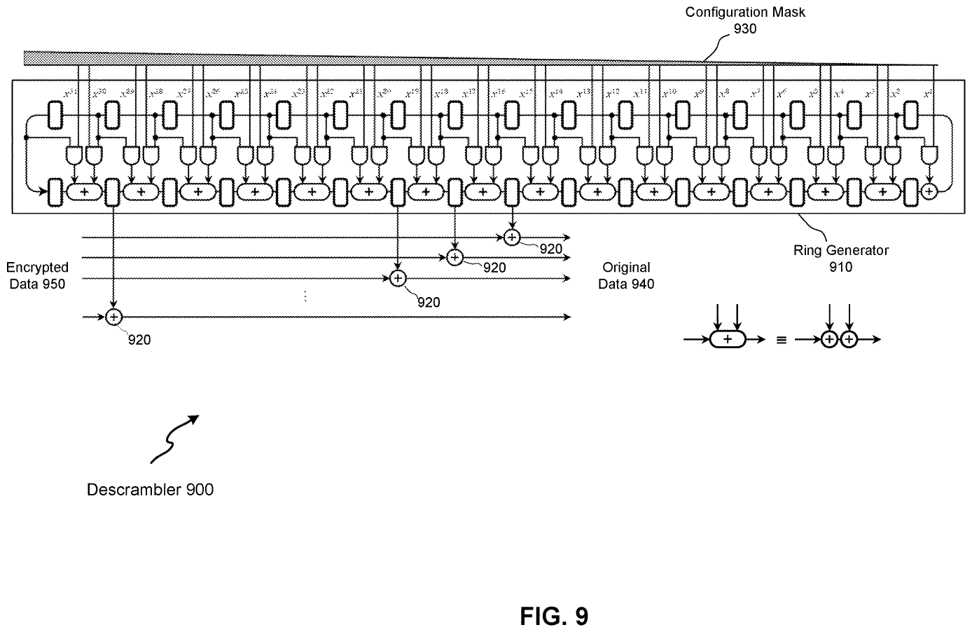

FIG. 9 illustrates an example descrambler 900 that may be implemented according to various embodiments of the disclosed technology. The descrambler 900 comprises a 32-bit ring generator 910 and XOR gates 920 and uses the principle of the Vernam stream cipher. Bits of a configuration mask 930 are injected into the 32-bit ring generator 910 through its feedback lines. The XOR gates 920 use the pseudorandom sequences produced by the 32-bit ring generator 910 to retrieve original data 940 from encrypted data 950. As discussed previously, a ring generator can operate at a high speed, enabling a ring-generator-based descrambler to work with other high-speed circuitry in the circuit. Further, the modular and programmable feedback network properties of a ring generator allow various characteristic polynomials to be implemented. This, in turn, allows one to pick a suitable secret configuration mask that may correspond to a primitive polynomial depending on other security needs.

A scrambler can use the same principles described above. A configuration mask for scrambling is injected into a ring generator in the same way as the configuration mask 930. Bits of the data to be scrambled are XORed with bits of the pseudorandom sequences produced by the ring generator. For scrambling, the locations for the encrypted data 950 and the original data 940 are switched.

An attempt to unauthorized access is detected when the response from the security server does not match what is expected. The detection can lead to a wrong descrambling mask. The wrong descrambling mask can trigger a peculiar feedback polynomial that is going to yield a pseudorandom sequence (even not necessarily a maximum-length on its own) that can effectively blur encrypted input data. The scrambler can obscure output data following the same principles.

Referring back to FIG. 8, the security components in the circuit 805 such as the random number generator 810, the hashing circuitry 820, and/or the retrieving circuitry 830 can be controlled by the controller 860. The controller 860 can be implemented using a simple finite-state machine. As discussed previously, the random number generator 810 can be implemented using the true random number generator 600 in FIG. 6 or the true random number generator 605 in FIG. 6B. It takes a preset number of clock cycles for the ring generator 610 in the true random number generator 600 to be ready for outputting the random number 815. Similarly, the hashing circuitry 820 also needs at least a certain number of clock cycles that suffice to rotate the content of the ring generator 826 multiple times before the hash value 825 is finalized and ready to be used for subsequent applications. Accordingly, the controller 860 can include a counter to determine the time needed in the operations of the random number generator 810 and the hashing circuitry 820. In addition to the finite-state machine and the counter, the controller 860 can comprise other components for additional functions such as self-testing.

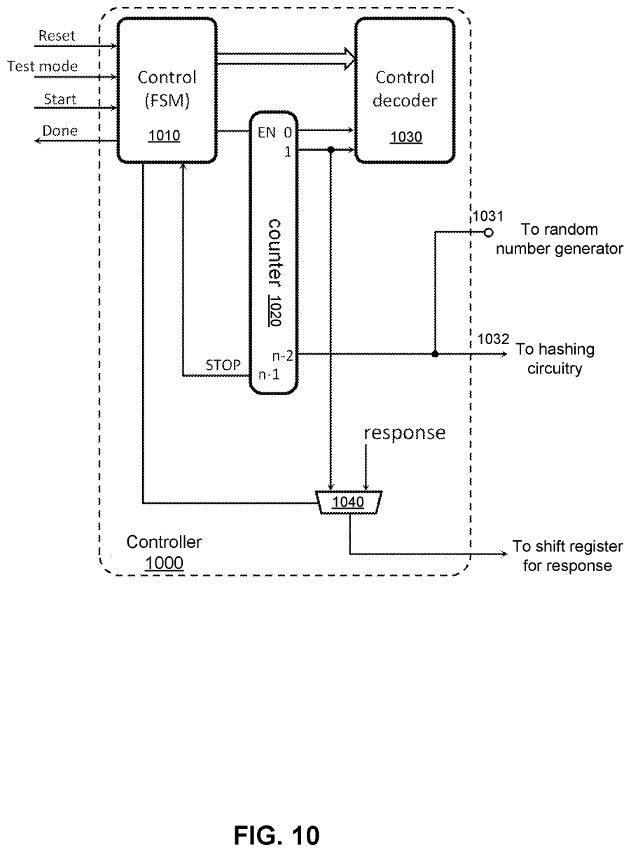

FIG. 10 illustrates an example of a controller 1000 that may be implemented according to various embodiments of the disclosed technology. The controller 1000 comprises a control unit 1010, a counter 1020, a control decoder 1030, and a multiplexer 1040. As noted previously, the control unit 1010 can be implemented using a finite-state machine circuit (FSM). The counter 1030 can control activity periods of both the random number generator and the hashing circuitry through outputs 1031 and 1032, respectively. The counter 1030 can also signal the control unit 1010 when its most significant output bit changes from 0 to 1, which can be used to terminate operations. The multiplexer 1040 and the control decoder 1030 can be used for self-testing. For example, the control decoder 1030 may be configured to provide stimuli for testing ring oscillators in a true random number generator. The multiplexer 1040 can allow sequences from the counter 1030 as test stimuli to test a shift register that is typically employed to store the response from the security server.

Referring back to FIG. 8 again, the security server 890 may be implemented by one or more computing systems/devices. Accordingly, one or more of the hash function unit 895, the configuration mask unit 897, and the design identification unit 892 may be implemented by executing programming instructions on one or more processors in one or more computing systems/devices. It should be appreciated that, while the hash function unit 895, the configuration mask unit 897, and the design identification unit 892 are shown as separate units in FIG. 8, a single computing system/device may be used to implement some or all of these units at different times, or components of these units at different times.

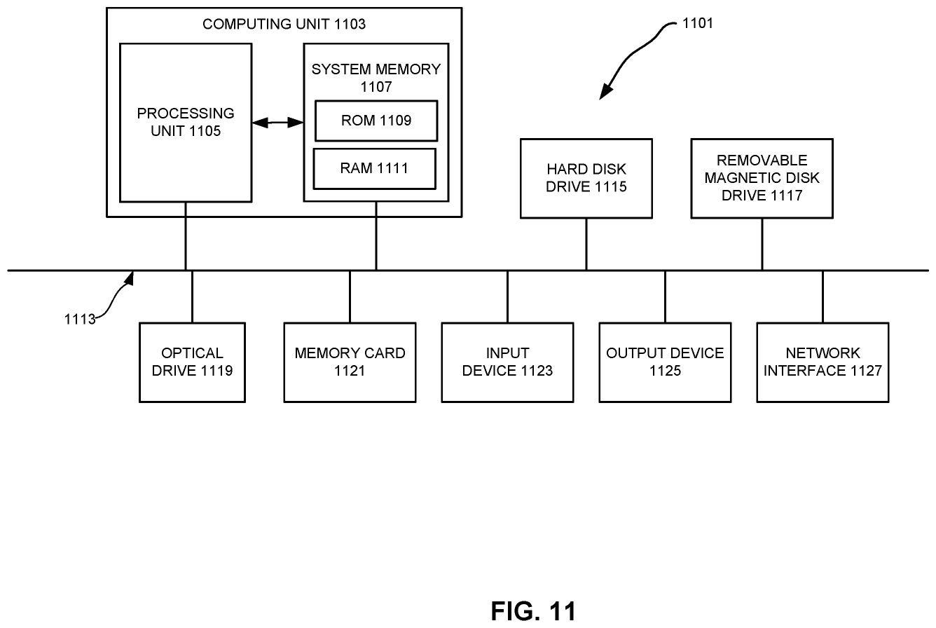

Various examples of the disclosed technology may be implemented through the execution of software instructions by a computing device, such as a programmable computer. Accordingly, FIG. 11 shows an illustrative example of a computing device 1101. As seen in this figure, the computing device 1101 includes a computing unit 1103 with a processing unit 1105 and a system memory 1107. The processing unit 1105 may be any type of programmable electronic device for executing software instructions, but it will conventionally be a microprocessor. The system memory 1107 may include both a read-only memory (ROM) 1109 and a random access memory (RAM) 1111. As will be appreciated by those of ordinary skill in the art, both the read-only memory (ROM) 1109 and the random access memory (RAM) 1111 may store software instructions for execution by the processing unit 1105.

The processing unit 1105 and the system memory 1107 are connected, either directly or indirectly, through a bus 1113 or alternate communication structure, to one or more peripheral devices. For example, the processing unit 1105 or the system memory 1107 may be directly or indirectly connected to one or more additional memory storage devices, such as a “hard” magnetic disk drive 1115, a removable magnetic disk drive 1117, an optical disk drive 1119, or a flash memory card 1121. The processing unit 1105 and the system memory 1107 also may be directly or indirectly connected to one or more input devices 1123 and one or more output devices 1125. The input devices 1123 may include, for example, a keyboard, a pointing device (such as a mouse, touchpad, stylus, trackball, or joystick), a scanner, a camera, and a microphone. The output devices 1125 may include, for example, a monitor display, a printer and speakers. With various examples of the computing device 1101, one or more of the peripheral devices 1115-1125 may be internally housed with the computing unit 1103. Alternately, one or more of the peripheral devices 1115-1125 may be external to the housing for the computing unit 1103 and connected to the bus 1113 through, for example, a Universal Serial Bus (USB) connection.

With some implementations, the computing unit 1103 may be directly or indirectly connected to one or more network interfaces 1127 for communicating with other devices making up a network. The network interface 1127 translates data and control signals from the computing unit 1103 into network messages according to one or more communication protocols, such as the transmission control protocol (TCP) and the Internet protocol (IP). Also, the network interface 1127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 1101 is illustrated as an example only, and it is not intended to be limiting. Various embodiments of the disclosed technology may be implemented using one or more computing devices that include the components of the computing device 1101 illustrated in FIG. 11, which include only a subset of the components illustrated in FIG. 11, or which include an alternate combination of components, including components that are not shown in FIG. 11. For example, various embodiments of the disclosed technology may be implemented using a multi-processor computer, a plurality of single and/or multiprocessor computers arranged into a network, or some combination of both.

### Conclusion

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

1. A circuit, comprising:
hashing circuitry configured to mimic a hashing function that can transform a random number into a hash value, the hashing circuitry comprising:
combinational circuitry comprising logic gates configured to serve as nonlinear Boolean operators, inputs of the combinational circuitry receiving bits of the random number; and
a ring generator configured to be initialized by a secret key, to be injected with bits from outputs of the combinational circuitry, and to output the hash value after a predefined number of clock cycles.

2. The circuit recited in claim 1, further comprising:
a nonvolatile storage device configured to store the secret key.

3. The circuit recited in claim 1, wherein the combinational circuitry is configured to receive a preset number of bits of the random number per clock cycle and to inject bits into the ring generator continuously for a plurality of clock cycles.

4. The circuit recited in claim 1, further comprising:
a random number generator configured to generate the random number.

5. The circuit recited in claim 4, wherein the random number generator comprises:
a ring generator; and
one or more inverter-based ring oscillators, the one or more inverter-based ring oscillators configured to inject bits into the ring generator at a plurality of location.

6. The circuit recited in claim 5, wherein the random number generator further comprises:
blocking circuitry configured to convert, based on a blocking signal, the ring generator into a circular shift register by blocking both the injection from the one or more inverter-based ring oscillators and internal feedbacks in the ring generator.

7. The circuit recited in claim 5, wherein at least one of the one or more inverter-based ring oscillators is configured to inject bits from outputs of some or all inverting elements in the at least one of the one or more inverter-based ring oscillators.

8. The circuit recited in claim 4, further comprising:
retrieving circuitry configured to use the hash value to retrieve one or more configuration masks from a response signal received by the circuit,
wherein the response signal is generated based on the random number by a computing device, the generating of the response signal comprising: generating the hash value for the random number, and combining the hash value with the one or more configuration masks.

9. The circuit recited in claim 8, further comprising:
a descrambler configured to use a configuration mask in the one or more configuration masks to descramble a signal received by the circuit.

10. The circuit recited in claim 9, wherein the descrambling the signal comprises retrieving compressed test patterns from encrypted compressed test patterns received by the circuit.

11. The circuit recited in claim 8, further comprising:
a scrambler configured to use a configuration mask in the one or more configuration masks to scramble a signal to be sent out by the circuit.

12. The circuit recited in claim 8, further comprising:
a controller configured to supervise an authentication process, the authentication process comprising:
generating the random number by the random number generator,
converting the random number into the hash value by the hashing circuitry, and
retrieving, by the retrieving circuitry, the one or more configuration masks from the response signal received by the circuit based on the hash value.

13. The circuit recited in claim 12, wherein the controller comprises a finite state machine.

14. One or more computer-readable media storing computer-executable instructions for causing a computer to perform a method, the method comprising:
creating, in a circuit design, a circuit, the circuit comprising:
hashing circuitry configured to mimic a hashing function that can transform a random number into a hash value, the hashing circuitry comprising:
combinational circuitry comprising logic gates configured to serve as nonlinear Boolean operators, inputs of the combinational circuitry receiving bits of the random number; and
a ring generator configured to be initialized by a secret key, to be injected with bits from outputs of the combinational circuitry, and to output the hash value after a predefined number of clock cycles.

15. The one or more non-transitory computer-readable media recited in claim 14, wherein the circuit further comprises:
a nonvolatile storage device configured to store the secret key.

16. The one or more non-transitory computer-readable media recited in claim 14, wherein the combinational circuitry is configured to receive a preset number of bits of the random number per clock cycle and to inject bits into the ring generator continuously for a plurality of clock cycles.

17. The one or more non-transitory computer-readable media recited in claim 14, wherein the circuit further comprises:
a random number generator configured to generate the random number.

18. The one or more non-transitory computer-readable media recited in claim 17, wherein the random number generator comprises:
a ring generator; and
one or more inverter-based ring oscillators, the one or more inverter-based ring oscillators configured to inject bits into the ring generator at a plurality of location.

19. The one or more non-transitory computer-readable media recited in claim 17, wherein the circuit further comprises:
retrieving circuitry configured to use the hash value to retrieve one or more configuration masks from a response signal received by the circuit,
wherein the response signal is generated based on the random number by a computing device, the generating of the response signal comprising: generating the hash value for the random number, and combining the hash value with the one or more configuration masks.
